(19) United States
(12) Patent Application Publication
(10) Pub. No.: US 2006/0070502 A1
(43) Pub. Date: Apr. 6, 2006

(54) Hunting knife and method of use

(76) Inventor: Lenvill C. Phipps, Dallas, TX (US)

Correspondence Address: LOCKE LIDDELL & SAPP LLP;ATTN: SUE COTT, 2200 ROSS AVENUE, SUITE 2200, DALLAS, TX, 75201-6776, US

(21) Appl. No.: 10/957,049

(22) Filed: Oct. 1, 2004

(51) Int. Cl. B26B 3/06

(52) U.S. Cl. 83/13; 30/153

(57) ABSTRACT

The present invention relates to a hunting knife for assisting a hunter in field dressing an animal, particularly for assistance with breaking the pelvic bone of the animal. The knife includes a handle, a blade and an extended element. The longitudinal axis of the knife and the longitudinal axis of the extended element are disposed generally parallel, as defined herein. A receiving slot is formed between the blade and the extended element for receiving a portion of the pelvic bone of the animal. The present invention includes sheaths for containing the knife of the present invention. A method for using the knife of the present invention includes the steps of contacting the knife to the portion of the pelvic bone desired to be broken and pulling up on the knife so as to break the bone.

### TECHNICAL FIELD OF THE INVENTION

The present invention relates to a hunting knife, and more particularly, to a hunting knife having an extended element for assistance in breaking the pelvic bone of an animal after a successful hunt.

### BACKGROUND OF THE INVENTION

The prior art hunting knifes used in field dressing a kill typically have only one blade that itself must be used to break the pelvic bone of the animal, e.g., deer, elk. The use of the blade for this purpose requires the user to exert force onto the pelvic bone to break it. Sometimes, the blade slips. In those instances, unwanted cutting can occur and possibly injury to the user. The unwanted cutting can cause internal organs to be punctured which can result in unwanted exposure of the game meat to the contents of the punctured organs.

Thus, there is a need to overcome these disadvantages.

### SUMMARY OF THE INVENTION

The present invention relates to a hunting knife having an extended element for assistance in breaking and splitting the pelvic bone of an animal after a successful hunt. Breaking and splitting the pelvic bone allows for the body cavity of the game animal to be opened to facilitate removal of the internal organs.

The extended element can be removably and/or adjustably connected to the knife so as to allow for removal and adjustment of the location of the extended element relative to the blade. The invention also includes novel sheaths for the knife.

In a preferred embodiment, the extended element includes a barb member.

Alternatively, the extended element can be retractably connected to the knife so as to retract into or adjacent to the handle.

The invention also relates to a method for using the knife of the invention.

### BRIEF DESCRIPTION OF THE DRAWINGS

For a more complete understanding of the invention and for further advantages thereof, reference is now made to the following Description of the Preferred Embodiments taken in conjunction with the accompanying Drawings in which:

FIG. 1 is a side perspective view of the knife including the extended element;

FIG. 2 is a front perspective view of the shank of the knife of FIG. 1;

FIG. 3 is a side perspective view of the knife of FIG. 1 showing the relative dispositions of the extended element and the blade;

FIG. 4 is a side perspective view of the extended element of the knife of FIG. 1;

FIG. 5 is a section view taken along the line 5-5 of FIG. 1 illustrating the dimensions of the blade and the extended element;

FIG. 6 illustrates a method for using the knife of FIG. 1 on an animal so as to break the pelvic bone.

FIG. 7 illustrates a sheath of the present invention for containing the knife of FIG. 1.

FIG. 8 illustrates another embodiment of a sheath of the present invention for containing the knife of FIG. 1.

### DESCRIPTION OF THE PREFERRED EMBODIMENTS

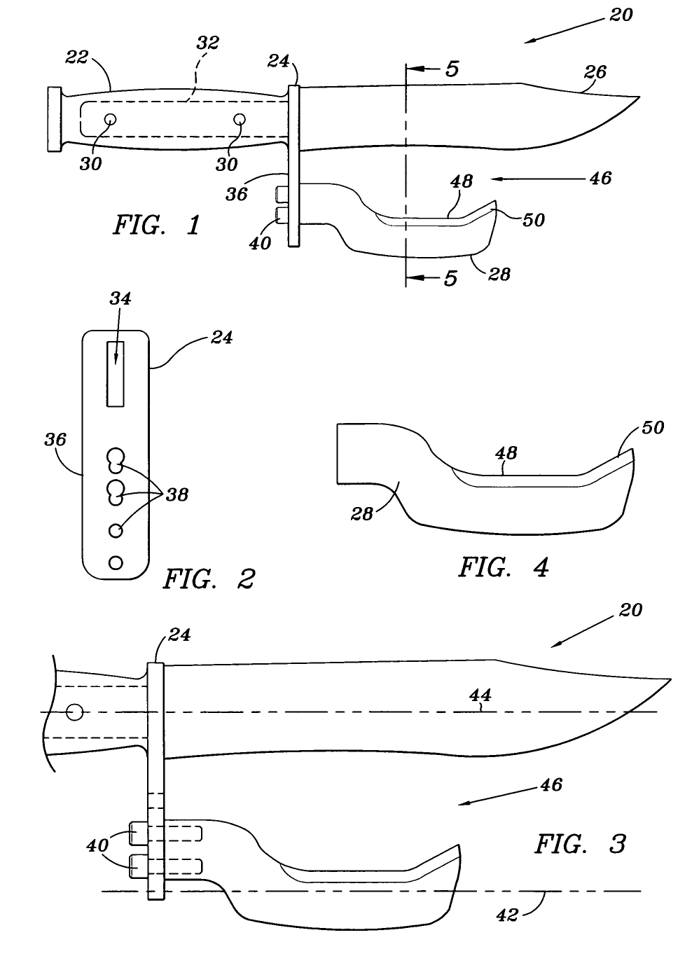

Referring to FIGS. 1-6, knife 20 of the present invention includes a handle 22, a shank 24, a blade 26 and an extended element 28. The blade 26 is connected to the handle 22 by any known connection including, but not limited to the use of bolts 30 in the handle 22. Bolts 30 can extend through handle 22 and tong 32 of blade 26.

As shown in FIG. 2, the shank 24 can be connected to knife 20 by any known connection, including but not limited to providing a tight fit between a slot 34 and the blade 26. The shank 24 preferably includes a connecting portion 36 for connecting the extended element 28 to the knife 20. Connecting portion 36 preferably includes a plurality of apertures 38 for receiving one or more securing members 40, as shown in FIGS. 1, 3, 6 and 7. Securing members 40 can serve to connect the shank 24 to the extended element 28.

The securing members 40 are preferably shoulder bolts that are adjustable to secure the extended element 28 to the shank 24.

As shown in FIG. 3, extended element 28 is preferably connected to knife 20 such that the longitudinal axis 42 of extended element 28 is generally parallel to the longitudinal axis 44 of knife 20.

As shown in FIG. 4, extended element 28 can include an edge 48 that is sharp. Extended element 28 can also include one or more barbs 50. Barbs 50 can serve to help grip the pelvic bone of the animal when using knife 20.

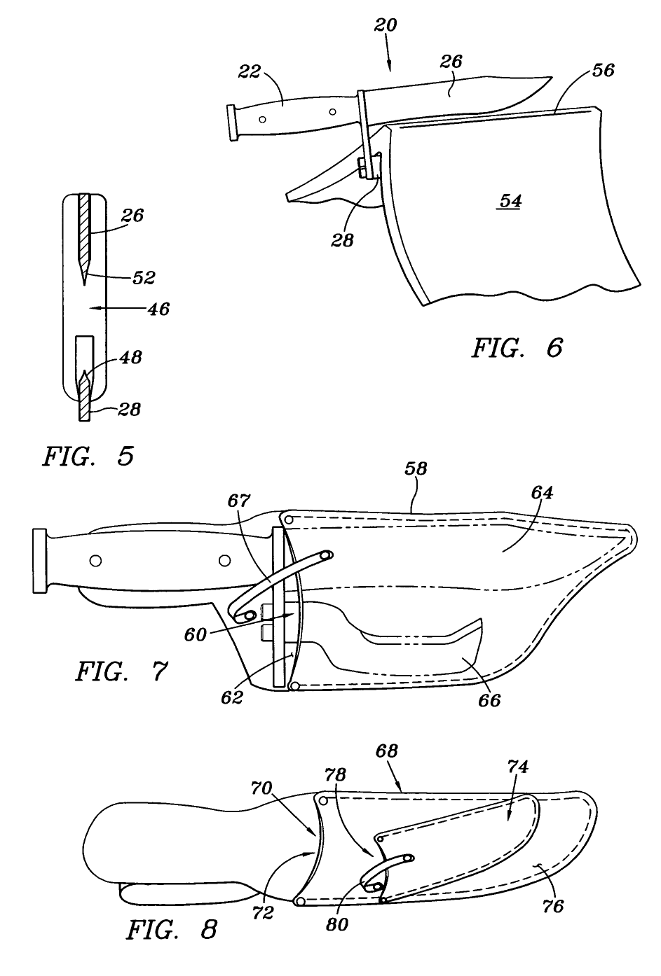

As shown in FIG. 5, blade 26 can include an edge 52 that is sharp and helps define receiving slot 46. Receiving slot 46, as shown in FIGS. 1, 3 and 5, can receive a portion of the pelvic bone that is desired to be broken, as shown in FIG. 6. As used herein, the phrase “generally parallel” is defined to include parallel as well as any angle sufficient to form a receiving slot 46.

As shown in FIG. 6, pelvic bone 54 includes a seam 56. Knife 20 can be used to break bone 54, preferably along seam 56.

Extended element 28 can also be connected to knife 20 by means of attachment to either the handle 22 or the blade 26. Moreover, the entire knife of the present invention can be formed of one piece of material. Thus, the above enumeration of portions of the knife using referencing numerals is not intended to convey that the separate portions of the knife 20 need be separate pieces.

A method for using the knife 20 of the present invention includes the following steps. The knife 20 is contacted to the pelvic bone 54 of an animal such that the blade 26 is disposed above the bone and the extended element 28 is disposed below the bone. Preferably, blade 26 is aligned with seam 56. Likewise, extended element 28 is preferably aligned with seam 56. A user of knife 20 can grab the handle 22 of knife 20. By pulling up on the handle 22 of the knife 20, the blade 26 can be forced down on the bone 54, preferably along seam 56. Force can simultaneously be exerted upward on bone 54 by the extended element 28, preferably along seam 56. As a result of such action, bone 54 can be broken.

As shown in FIG. 7, knife 20 can be disposed within a sheath 58. Sheath 58 is designed to cover blade 26 and extended element 28. Sheath 58 includes receiving chamber 60. Receiving chamber 60 is defined by the interior surface 62 of sheath 58. Sheath 58 is preferably made of leather. Receiving chamber 60 includes blade column 64 and extended element column 66. Blade column 64 is designed so as to receive blade 26. Extended element column 66 is designed to receive extended element 28. Sheath 58 preferably includes a latch 67. Latch 67 can be releasably connected to sheath 58 to help keep knife 20 within sheath 58.

As shown in FIG. 8, knife 20 can be disposed in a sheath 68 when extended element 28 has been detached or disconnected. Sheath 68 includes a chamber 70. Chamber 70 is defined by the interior surface 72 of sheath 68. Sheath 68 is preferably made of leather. Sheath 68 also include pouch 74. Pouch 74 is connected to the outer surface 76 of sheath 68 and defines a pocket 78. Pocket 78 is designed to receive extended element 28 as it is removed or disconnected from knife 20. Pouch 74 is preferably connected to sheath 68 at an angle as compared to chamber 70. Sheath 68 preferably includes a latch 80. Latch 80 can be releasably connected to sheath 68 so as to help keep extended element 28 within pocket 78.

Although the preferred embodiments of the present invention have been illustrated in the accompanying drawings and described in the foregoing Description of the Preferred Embodiments, it will be understood that the invention is not limited to the embodiments disclosed but is capable of numerous rearrangements, modifications, and substitutions of parts and elements without departing from the spirit of the invention.

I claim:

1. A knife having a longitudinal axis comprising:
a handle;
a blade; and
an extended element having a longitudinal axis wherein said extended element is connected to said knife such that the longitudinal axis of the extended element is generally parallel to the longitudinal axis of said knife.

2. The knife of claim 1 wherein said extended element forms a receiving slot for receiving the pelvic bone of an animal.

3. The knife of claim 1 further comprising a shank connected to said knife wherein said shank connects said extended element to said knife.

4. The knife of claim 1 wherein the extended element is removably connected to said knife.

5. The knife of claim 1 wherein the extended element is adjustably connected to said knife.

6. The knife of claim 2 wherein said extended element includes an edge facing said receiving slot that is sharp.

7. The knife of claim 2 wherein said extended element includes an edge facing said receiving slot that includes a barb.

8. The knife of claim 3 wherein said shank has a connecting portion.

9. The knife of claim 8 further comprising a plurality of apertures in the connecting portion of said shank.

10. The knife of claim 9 further comprising a securing member for connecting said extended element to said shank through one or more of said apertures.

11. The knife of claim 9 wherein said apertures are disposed in the connecting portion of said shank so as to allow for multiple positions for the extended portion to be connected to said knife.

12. A knife comprising:
a handle;
a blade; and
an extended element connected to said knife so as to form a receiving slot for receiving the pelvic bone of an animal.

13. A sheath for the knife of claim 12 comprising a receiving chamber having an interior surface wherein the interior surface defines a blade column for receiving the blade of said knife and an extended element column for receiving the extended element of said knife.

14. The sheath of claim 13 further comprising a latch releasably connected thereto so as to help keep said knife in said sheath.

15. A sheath for the knife of claim 12 comprising a chamber having an interior surface and an outer surface and a pouch forming a pocket on said outer surface wherein said chamber can receive the blade after the extended element has been disconnected from the knife and the pocket can receive the disconnected extended element.

16. The sheath of claim 15 further comprising a latch releasably connected thereto so as to help keep said extended element in said pocket.

17. The sheath of claim 15 wherein said pouch is connected on the outer surface of said chamber at an angle with respect to said chamber.

18. A method of using the knife of claim 1 comprising the following steps:
contacting said knife to a pelvic bone of an animal such that the blade is disposed above the bone and the extended element is disposed below the bone;
grabbing the handle of said knife;
pulling up on the handle of said knife such that the blade is forced down on the bone and the extended element is forced up on the bone; and
breaking the pelvic bone of the animal.

19. The method of claim 18 further comprising the step of aligning said blade with the seam of said bone.

20. The method of claim 18 further comprising the step of aligning said extended element with the seam of said bone.
